(19) United States
(12) Patent Application Publication
(10) Pub. No.: US 2015/0111595 A1
(43) Pub. Date: Apr. 23, 2015

(54) METHOD OF SCHEDULING SPECTRUM SENSING AND METHOD OF ALLOCATING UPLINK RADIO RESOURCES IN COGNITIVE RADIO COMMUNICATION SYSTEM

(71) Applicant: Electronics and Telecommunications Research Institute, Daejeon (KR)

(72) Inventors: Sung-Jin YOO, Daejeon (KR); Sung-Hyun HWANG, Daejeon (KR); Jung-Sun UM, Daejeon (KR); Byung-Jang JEONG, Daejeon (KR)

(21) Appl. No.: 14/304,352

(22) Filed: Jun. 13, 2014

(30) Foreign Application Priority Data
Oct. 17, 2013 (KR) 10-2013-0124064

(51) Int. Cl. H04W 16/14; H04W 72/04

(52) U.S. Cl. CPC H04W 16/14; H04W 72/0406
USPC 455/454

(57) ABSTRACT

Provided are a method of scheduling spectrum sensing and a method of allocation uplink radio resource in a cognitive radio communication system. The method of scheduling spectrum sensing in a cognitive radio communication system includes classifying terminals in a cell into terminals affecting spectrum sensing and terminals not affecting spectrum sensing, and performing spectrum sensing when it is determined that uplink signals of other terminals do not affect spectrum sensing based on results of the classification.

### CROSS-REFERENCE TO RELATED APPLICATION

This application claims priority to and the benefit of Korean Patent Application No. 2013-0124064, filed on Oct. 17, 2013, the disclosure of which is incorporated herein by reference in its entirety.

### BACKGROUND

1. Field of the Invention

The present invention relates to cognitive radio communication technology, and more particularly, to a method of scheduling spectrum sensing and a method of allocating uplink radio resources in a cognitive radio communication system.

2. Discussion of Related Art

With a recent dramatic increase in demand for wireless communication, demand for spectrum resources that are media for wireless communication is increasing together. To ensure new spectrum resources, each country over the world is changing its frequency policy. In particular, there is a band which has been allocated spectrum resources but is not in use, and to make better use of such a white space, a change in the frequency policy for allowing not only a primary user but also a secondary user to utilize the white space is expected.

To utilize such a white space, a primary user needs to be protected, and to this end, there is a necessity for information regarding whether or not the primary user is utilizing the corresponding spectrum band. A method for obtaining such information is spectrum sensing.

When a secondary user carries out data transmission while another secondary user is performing spectrum sensing, sensing sensitivity may deteriorate. Therefore, in general, a quiet period is set to prevent another secondary user from utilizing the corresponding band, and spectrum sensing is performed during the quiet period. The Institute of Electrical and Electronics Engineers (IEEE) 802.22 standard includes a protocol for controlling such a quiet period.

Such a quiet period is regarded as being essential for effective spectrum sensing. However, data transmission of secondary users is stopped during the quiet period, and thus efficiency in the use of spectrum resources by secondary users is reduced.

### SUMMARY OF THE INVENTION

The present invention is directed to a method of scheduling spectrum sensing in a cognitive radio communication system for increasing efficiency in the use of spectrum resources by secondary users by minimizing a quiet period for spectrum sensing, and a method of allocating uplink radio resources for efficient spectrum sensing.

According to an aspect of the present invention, there is provided a method of scheduling spectrum sensing in a cognitive radio communication system, the scheduling being performed by a terminal, the method including: classifying terminals in a cell into terminals affecting spectrum sensing and terminals not affecting spectrum sensing; and performing spectrum sensing when it is determined that uplink signals of other terminals do not affect spectrum sensing based on results of the classification.

The classifying of the terminals may include classifying the terminals based on uplink radio resource information transmitted from a base station.

The classifying of the terminals may include classifying the terminals according to amounts of interference respectively caused by the uplink signals of the terminals.

The classifying of the terminals may include classifying the terminals according to whether or not an amount of interference caused by an uplink signal of each terminal exceeds a predetermined threshold value.

The performing of the spectrum sensing may include: determining whether terminals classified as the terminals affecting spectrum sensing are transmitting uplink signals; and performing the spectrum sensing when it is determined that the terminals are not transmitting uplink signals.

The performing of the spectrum sensing may include performing no spectrum sensing when it is determined that the terminals are transmitting uplink signals.

The performing of the spectrum sensing may include performing the spectrum sensing while terminals classified as the terminals not affecting spectrum sensing are transmitting uplink signals.

According to another aspect of the present invention, there is provided a method of allocating uplink radio resources in a cognitive radio communication system, the allocating being performed by a base station, the method including: deriving influence relationships between data transmission and spectrum sensing of terminals in a cell; and allocating uplink radio resources to the terminals based on the derived influence relationships.

The deriving of the influence relationships may include deriving the influence relationships using spectrum sensing influence information collected from the terminals in the cell.

The influence relationships may include spectrum sensing influence patterns indicating whether or not data transmission of each terminal in the cell affects spectrum sensing of other terminals.

The allocating of the uplink radio resources may include allocating same time resources to terminals having a relatively small difference in the spectrum sensing influence pattern.

The allocating of the uplink radio resources may include: calculating indices of differences in the spectrum sensing influence pattern between the terminals; grouping the terminals according to the indices of the differences in the spectrum sensing influence pattern; and allocating the uplink radio resources to the terminals based on results of the grouping.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 shows an example of a wireless communication system to which exemplary embodiments of the present invention can be applied;

FIG. 2 is a table showing whether or not transmission of one terminal affects spectrum sensing of other terminals in the wireless communication system of FIG. 1;

FIG. 3 is a table showing whether or not transmission of each of all terminals in a cell affects spectrum sensing of other terminals;

FIG. 4 is a schematic flowchart illustrating a method of scheduling spectrum sensing according to an exemplary embodiment of the present invention;

FIG. 5 is a detailed flowchart illustrating a process of classifying terminals into terminals affecting spectrum sensing and terminals not affecting spectrum sensing;

FIG. 6 is a detailed flowchart illustrating a process of performing spectrum sensing according to influence of terminals on spectrum sensing;

FIGS. 7 and 8 show examples in which terminals operate according to exemplary embodiments of the present invention;

FIG. 9 is a flowchart illustrating a method for a base station to allocate uplink radio resources according to an exemplary embodiment of the present invention;

FIG. 10 is a table showing an example of influence relationships between data transmission and spectrum sensing of terminals in a cell derived by a base station;

FIG. 11 is a table showing indices of differences in a spectrum sensing influence pattern between terminals;

FIG. 12 shows examples of terminals grouped according to indices of differences in a spectrum sensing influence pattern; and

FIG. 13 shows an example of a form in which radio resources are allocated to terminals according to exemplary embodiments of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention. In the following description and the accompanying drawings, substantially the same components will be denoted by the same reference numerals, and a description thereof will not be reiterated. Also, in the description of the present invention, if it is determined that a detailed description of a well-known function or structure related to the invention may unnecessarily obscure the subject matter of the invention, the detailed description will be omitted.

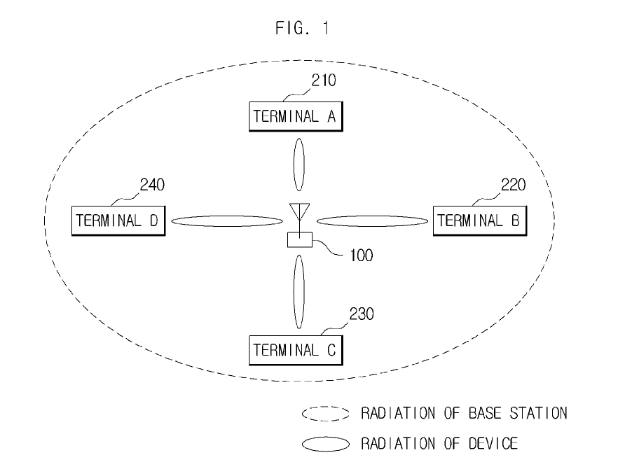

FIG. 1 shows an example of a wireless communication system to which exemplary embodiments of the present invention can be applied. Referring to FIG. 1, a wireless communication system includes a base station 100, and a plurality of terminals 210, 220, 230, and 240 present in a cell covered by the base station 100. In general, the base station 100 transmits and receives signals using an omnidirectional antenna. Therefore, as shown in the drawing, the base station 100 has a radiation pattern of a circular shape or an elliptical shape close to a circular shape. In exemplary embodiments of the present invention, the terminals 210, 220, 230, and 240 exchange signals using directional antennas. Therefore, as shown in the drawing, the terminals 210, 220, 230, and 240 have radiation patterns in specific directions, for example, directed toward the base station 100.

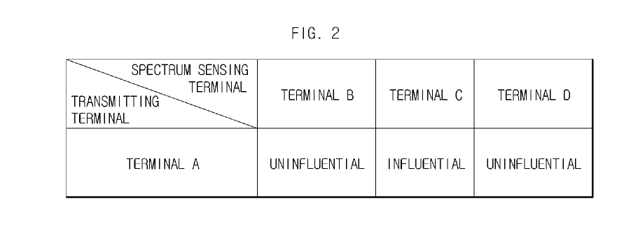

A radio wave transmitted by the base station 100 arrives at all the terminals 210, 220, 230, and 240, whereas a radio wave transmitted by each terminal may or may not arrive at another terminal according to a location of the terminal and a state of a wireless channel. Therefore, a radio wave transmitted by each terminal may or may not affect spectrum sensing performed by another terminal according to a location of the terminal and a state of a wireless channel. For example, when terminal A 210 transmits an uplink signal to the base station 100, spectrum sensing performed by terminal C 230 may be affected by the uplink signal of terminal A 210, but spectrum sensing performed by terminal B 220 and terminal D 240 may be hardly affected by the uplink signal of terminal A 210. FIG. 2 is a table showing whether or not transmission of terminal A 210 affects spectrum sensing of terminal B 220, terminal C 230, and terminal D 240. Referring to FIG. 2, transmission of terminal A 210 affects spectrum sensing of terminal C 230 but does not affect spectrum sensing of terminal B 220 and terminal D 240.

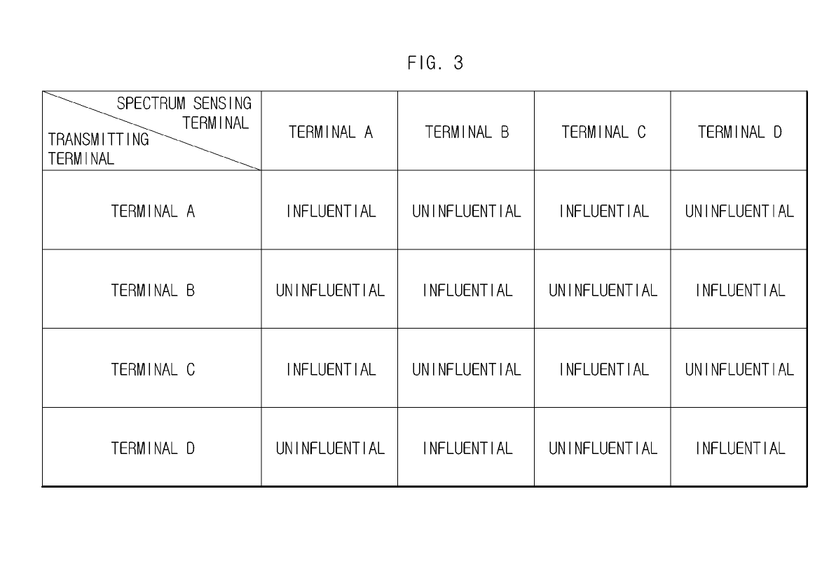

Likewise, FIG. 3 is a table showing whether or not transmission of each of all terminals in a cell affects spectrum sensing of other terminals. Referring to FIG. 3, for example, transmission of terminal B 220 affects spectrum sensing of terminal B 220 and terminal D 240 but does not affect spectrum sensing of terminal A 210 and terminal C 230.

If it is possible to know such information in advance, even when a terminal transmits an uplink signal, a terminal of which spectrum sensing is not affected by the transmission may perform spectrum sensing. For example, terminal B 220 and terminal D 240 may perform spectrum sensing while terminal A 210 or terminal C 230 is transmitting an uplink signal, and terminal A 210 and terminal C 230 may perform spectrum sensing while terminal B 220 or terminal D 240 is transmitting an uplink signal. When transmission of an uplink signal and spectrum sensing are simultaneously performed in this way, a quiet period for spectrum sensing may be removed or reduced, and thus it is possible to increase efficiency in the use of spectrum resources by secondary users. To maximize such an effect, terminals affecting each other may be caused to perform transmission at the same time, and terminals not affecting each other may be caused to perform transmission at different times. For example, terminal A 210 and terminal C 230 transmit uplink signals at the same time, and terminal B 220 and terminal D 240 transmit uplink signals at the same time.

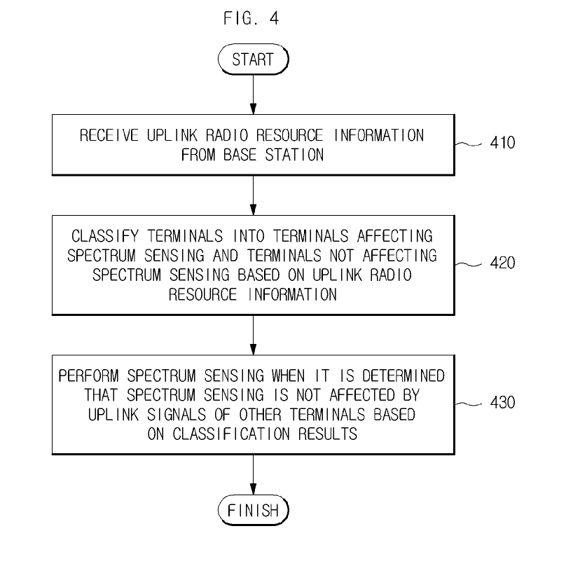

FIG. 4 is a schematic flowchart illustrating a method of scheduling spectrum sensing in consideration of the above-described relationships between transmission of an uplink signal and spectrum sensing according to an exemplary embodiment of the present invention. The method of scheduling spectrum sensing according to this exemplary embodiment is a procedure performed by an arbitrary terminal, and each terminal in a cell may independently perform the method of scheduling spectrum sensing according to this exemplary embodiment.

Referring to FIG. 4, in step 410, a terminal receives uplink radio resource information from a base station. In general, the base station transmits uplink radio resource information for each terminal to terminals in a cell, and each terminal acquires uplink radio resources for transmitting data to the base station based on the information received from the base station. The uplink radio resource information may be terminal information, radio resource allocation information, frequency channel information, time channel information, channel state information, and so on. In step 410, the terminal may acquire uplink radio resource information for other terminals as well as uplink radio resource information for the terminal itself.

In step 420, the terminal classifies the terminals in the cell into terminals affecting its spectrum sensing and terminals not affecting its spectrum sensing based on the received uplink radio resource information. For example, in the case described above with reference to FIG. 1, terminal A 210 classifies terminal C 230 as a terminal affecting its spectrum sensing, and terminal B 220 and terminal D 240 as terminals not affecting its spectrum sensing.

In step 430, the terminal performs spectrum sensing when it is determined that uplink signals of other terminals do not affect spectrum sensing of the terminal based on results of the classification of step 420. Since the terminal has classified the terminals into terminals affecting its spectrum sensing and terminals not affecting its spectrum sensing in step 420, in this step, it is possible to find out whether or not uplink signals of the terminals classified as terminals affecting spectrum sensing of the terminal affect spectrum sensing of the terminal and to perform spectrum sensing accordingly.

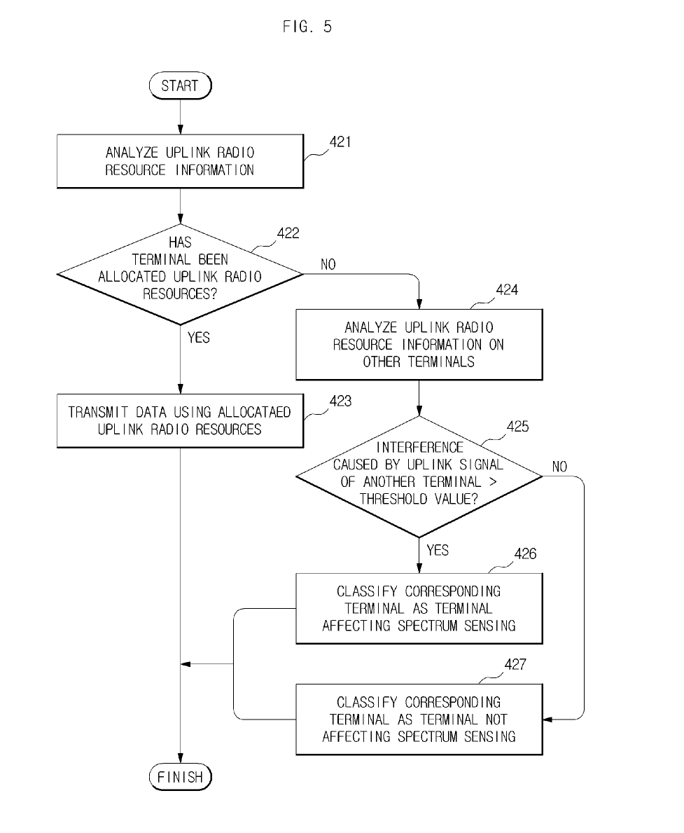

FIG. 5 is a detailed flowchart illustrating step 420, that is, a process of classifying terminals into terminals affecting spectrum sensing and terminals not affecting spectrum sensing.

Referring to FIG. 5, in step 421, the terminal analyzes the uplink radio resource information received from the base station.

When analysis results of the uplink radio resource information indicate that the terminal has been allocated uplink radio resources in step 422, the process proceeds to step 423, and the terminal transmits data to the base station using the allocated uplink radio resources.

On the other hand, when the analysis results of the uplink radio resource information indicate that the terminal has been allocated no uplink radio resources in step 422, the process proceeds to step 424, and the terminal analyzes uplink radio resource information on the other terminals.

In step 425, the terminal determines whether the amount of interference caused by an uplink signal of each of the other terminals exceeds a predetermined threshold value. The amount of interference caused by an uplink signal of another terminal may be estimated based on terminal information, radio resource allocation information, frequency channel information, time channel information, channel state information, etc. on the other terminal.

When it is determined in step 425 that the amount of interference of a terminal exceeds the threshold value, the corresponding terminal is classified as a terminal affecting spectrum sensing in step 426.

On the other hand, when it is determined in step 425 that the amount of interference of a terminal does not exceed the threshold value, the corresponding terminal is classified as a terminal not affecting spectrum sensing in step 427.

Through the above-described process, the terminal may classify the terminals in the cell of the base station into terminals affecting spectrum sensing and terminals not affecting spectrum sensing.

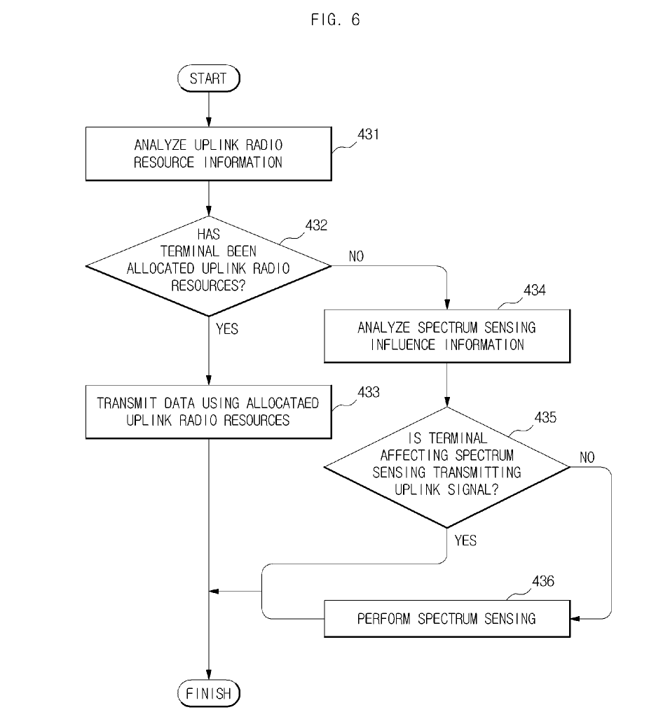

FIG. 6 is a detailed flowchart illustrating step 430, that is, a process of performing spectrum sensing according to influence of other terminals on spectrum sensing.

Referring to FIG. 6, in step 431, the terminal analyzes the uplink radio resource information received from the base station.

When analysis results of the uplink radio resource information indicate that the terminal has been allocated uplink radio resources in step 432, the process proceeds to step 433, and the terminal transmits data to the base station using the allocated uplink radio resources.

Step 431 to step 433 are identical to step 421 to step 423 of FIG. 5, but correspond to a process for transmitting data using uplink radio resources newly allocated to the terminal. Since it has been checked once whether uplink radio resources are allocated to the terminal through step 421 to step 423 of FIG. 5, step 431 to step 433 may be omitted.

When the analysis results of the uplink radio resource information indicate that the terminal has been allocated no uplink radio resources in step 432, the process proceeds to step 434, and the terminal analyzes spectrum sensing influence information obtained in step 420. Through the analysis, the terminal may extract terminals not affecting spectrum sensing.

In step 435, the terminal determines whether the terminals classified as terminals affecting spectrum sensing of the terminal are transmitting uplink signals. Whether or not the terminals classified as terminals affecting spectrum sensing of the terminal are transmitting uplink signals may be estimated based on terminal information, radio resource allocation information, frequency channel information, time channel information, channel state information, etc. on the terminals affecting spectrum sensing of the terminal obtained from the uplink radio resource information received from the base station, or may be determined by sensing uplink signals of the terminals affecting spectrum sensing of the terminal.

When it is determined in step 435 that no uplink signal is being transmitted, the process proceeds to step 436, and spectrum sensing is performed for the corresponding radio resources.

On the other hand, when it is determined in step 435 that an uplink signal is being transmitted, no spectrum sensing is performed for the corresponding radio resources, and the process ends.

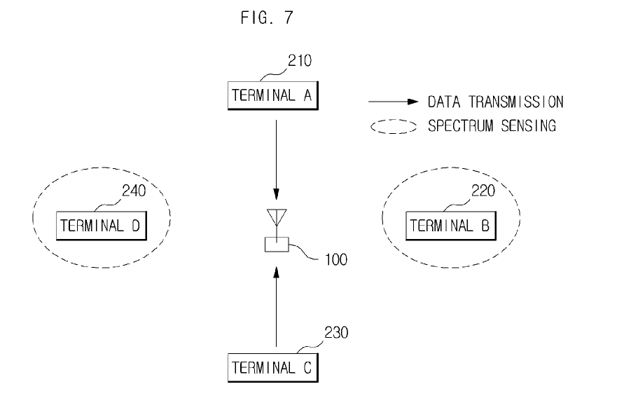

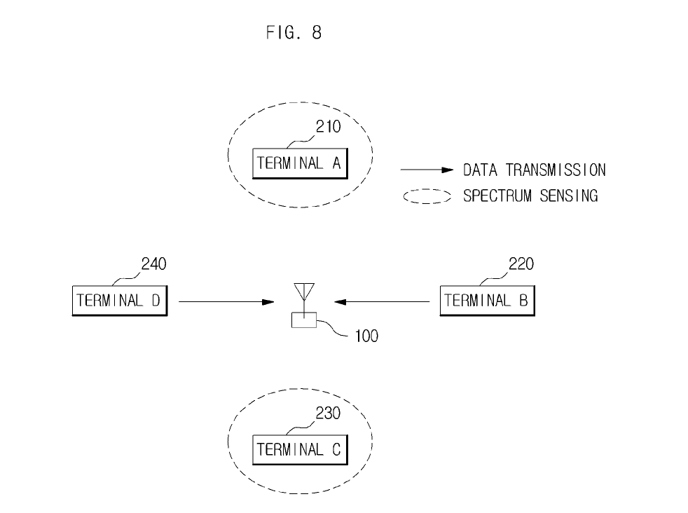

FIGS. 7 and 8 show examples in which terminals operate in the wireless communication system of FIG. 1 according to the above-described exemplary embodiment of the present invention. In these operational examples, it is assumed that each of the terminals 210, 220, 230, and 240 has found out the spectrum sensing influence information shown in FIG. 3 based on uplink radio resource information received from the base station 100.

Referring to FIG. 7, terminal A 210 and terminal C 230 are allocated uplink radio resources by the base station 100 and are transmitting data, and at the same time, terminal B 220 and terminal D 240 are performing spectrum sensing. In other words, terminal A 210 and terminal C 230 do not affect spectrum sensing of terminal B 220 and terminal D 240, and thus terminal B 220 and terminal D 240 may perform spectrum sensing while terminal A 210 and terminal C 230 are transmitting data.

Referring to FIG. 8, terminal B 220 and terminal D 240 are allocated uplink radio resources by the base station 100 and are transmitting data, and at the same time, terminal A 210 and terminal C 230 are performing spectrum sensing. In other words, terminal B 220 and terminal D 240 do not affect spectrum sensing of terminal A 210 and terminal C 230, and thus terminal A 210 and terminal C 230 may perform spectrum sensing while terminal B 220 and terminal D 240 are transmitting data.

As described above, using the method of scheduling spectrum sensing according to an embodiment of the present invention, some terminals may transmit uplink data, and at the same time, other terminals may perform spectrum sensing. Therefore, it is possible to minimize waste of radio resources caused by a quiet period for spectrum sensing.

Furthermore, when a base station has spectrum sensing influence information that each terminal has, it is possible to more effectively reduce a quiet period for spectrum sensing. This may be achieved by allocating the same time resources to terminals having relatively similar spectrum sensing influence information.

For example, on an assumption of the spectrum sensing influence information shown in FIG. 3, a first uplink time period may be allocated to terminal A 210 and terminal C 230, and a second uplink time period different from the first uplink time period may be allocated to terminal B 220 and terminal D 240. Then, terminal B 220 and terminal D 240 may perform spectrum sensing during the first uplink time period, and terminal A 210 and terminal C 230 may perform spectrum sensing during the second uplink time period, so that radio resources may be efficiently utilized. However, when radio resources are allocated without considering spectrum sensing influence information of each terminal, uplink signals of other terminals may make it difficult to perform spectrum sensing, and there is a necessity for a quiet period. For example, suppose that a first uplink time period is allocated to terminal A 210 and terminal B 220, and a second uplink time period is allocated to terminal C 230 and terminal D 240. Then, during the first uplink time period, terminal A 210 will transmit data to the base station 100, and terminal C 230 will attempt spectrum sensing because terminal C 230 has been allocated no radio resources. However, terminal A 210 affects spectrum sensing of terminal C 230, and thus a quiet period is necessary for terminal C 230 to perform spectrum sensing.

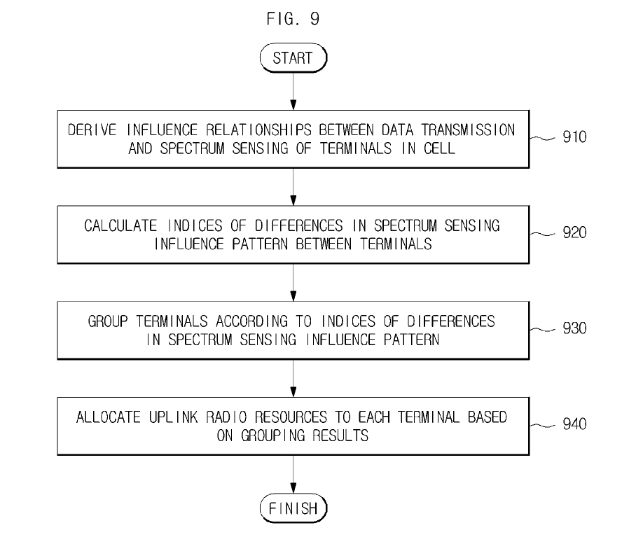

Therefore, the present invention proposes a method for a base station to effectively allocate uplink radio resources using spectrum sensing influence information. FIG. 9 is a flowchart illustrating a method for a base station to allocate uplink radio resources according to an exemplary embodiment of the present invention.

Referring to FIG. 9, in step 910, a base station derives influence relationships between data transmission and spectrum sensing of terminals in a cell. The base station collects spectrum sensing influence information that each terminal has from the terminals in the cell, and put the collected information together, thereby finding out influence relationships between data transmission and spectrum sensing of the terminals. To this end, as described above with reference to FIGS. 4 and 5, each terminal may maintain and update spectrum sensing influence information, which is classification information on terminals affecting spectrum sensing and terminals not affecting spectrum sensing, based on uplink radio resource information transmitted from the base station, and may periodically transmit spectrum sensing influence information that it has to the base station.

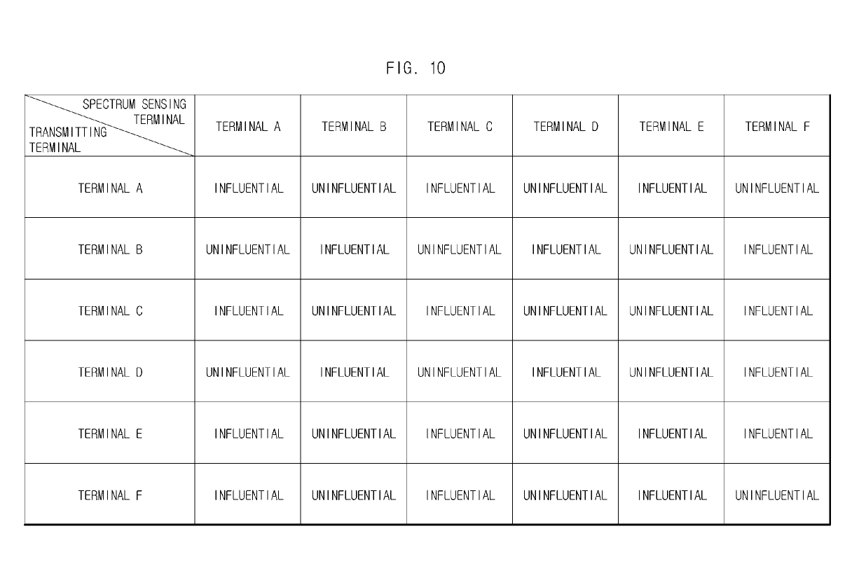

FIG. 10 is a table showing an example of influence relationships between data transmission and spectrum sensing of terminals in a cell derived by a base station. Such influence relationships consist of spectrum sensing influence patterns indicating whether or not data transmission of each terminal affects spectrum sensing of other terminals. Referring to FIG. 10, there are terminals A, B, C, D, E, and F in a cell. Here, data transmission of terminal A does not affect spectrum sensing of terminals B, D, and F. In other words, while terminal A is transmitting data, terminals B, D, and F may perform spectrum sensing. Data transmission of terminal B does not affect spectrum sensing of terminals A, C, and E, and data transmission of terminal C does not affect spectrum sensing of terminals B, D, and E. Data transmission of terminal D does not affect spectrum sensing of terminals A, C, and E, and data transmission of terminal E does not affect spectrum sensing of terminals B and D. Lastly, data transmission of terminal F does not affect spectrum sensing of terminals B, D, and F.

Referring back to FIG. 9, in step 920, the base station calculates indices of differences in spectrum sensing influence patterns between terminals based on the influence relationships between data transmission and spectrum sensing found in step 910. For example, when all spectrum sensing terminals have the same influence relationship with transmitting terminals, the index may be 0, and when the spectrum sensing terminals have different influence relationships with the transmitting terminals, the index may be the number of different factors.

For example, referring to FIG. 10, when terminal A and terminal F are compared with each other, spectrum sensing influence patterns of the transmitting terminals are (influence O, influence X, influence O, influence X, influence O, influence X), that is, all the factors of terminal A are the same as those of terminal F. Since there is no difference in the spectrum sensing influence patterns, the index may be 0. When terminal A and terminal B are compared with each other, terminal A has a pattern (influence O, influence X, influence O, influence X, influence O, influence X), and terminal B has a pattern (influence X, influence O, influence X, influence O, influence X, influence O). In other words, all the six factors of terminal A differ from those of terminal B. Therefore, the index of differences in the spectrum sensing influence patterns between terminal A and terminal B may be 6. When terminal A and terminal C are compared with each other, terminal A has a pattern (influence O, influence X, influence O, influence X, influence O, influence X), and terminal C has a pattern (influence O, influence X, influence O, influence X, influence X, influence O). In other words, two factors of terminal A differ from those of terminal C. Therefore, the index of differences in the spectrum sensing influence patterns between terminal A and terminal C may be 2.

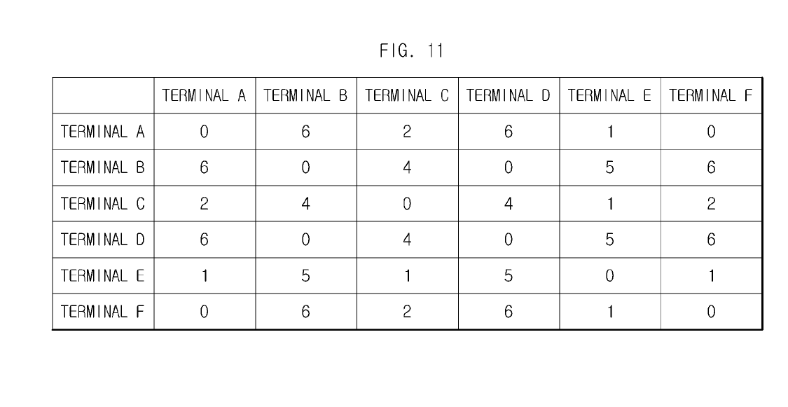

FIG. 11 is a table showing indices of differences in a spectrum sensing influence pattern between terminals calculated as described above.

A small index of differences in spectrum sensing influence patterns between two terminals denotes that the two terminals considerably affect spectrum sensing to each other, and a large index of differences in spectrum sensing influence patterns between two terminals denotes that the two terminals slightly affect spectrum sensing to each other.

For example, the index of differences in spectrum sensing influence patterns between terminal A and terminal F is 0, and thus it is possible to know that terminal A and terminal F greatly affect spectrum sensing to each other. On the other hand, the index of differences in spectrum sensing influence patterns between terminal A and terminal B is 6, and thus it is possible to know that terminal A and terminal B very slightly affect spectrum sensing to each other. Since the index of differences in spectrum sensing influence patterns between terminal A and terminal E is 1, and thus it is possible to know that terminal A and terminal E significantly affect spectrum sensing to each other.

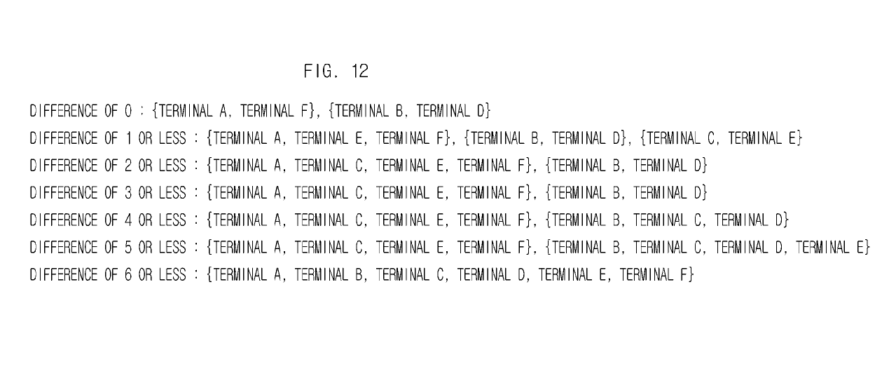

Referring back to FIG. 9, in step 930, the base station groups the terminals according to indices of differences in spectrum sensing influence patterns. In the example of FIG. 11, indices of differences in spectrum sensing influence patterns have values from 0 to 6, and thus the terminals may be grouped into, for example, terminal groups whose index of differences in the spectrum sensing influence patterns is 0, terminal groups whose index of differences in the spectrum sensing influence patterns is 1 or less, terminal groups whose index of differences in the spectrum sensing influence patterns is 2 or less, terminal groups whose index of differences in the spectrum sensing influence patterns is 3 or less, terminal groups whose index of differences in the spectrum sensing influence patterns is 4 or less, terminal groups whose index of differences in the spectrum sensing influence patterns is 5 or less, and terminal groups whose index of differences in the spectrum sensing influence patterns is 6 or less as shown in FIG. 12.

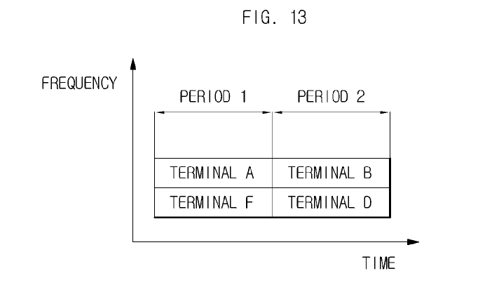

In step 940, the base station allocates uplink radio resources to each terminal based on grouping results of the terminals. Uplink radio resource allocation information is transmitted from the base station to the terminals. To reduce a quiet period for spectrum sensing, it is necessary to allocate the same time resources to terminals that considerably affect spectrum sensing to each other and allocate different time resources to terminals that slightly affect spectrum sensing to each other. Therefore, in an exemplary embodiment of the present invention, the same time resources are allocated to terminals having relatively small difference in spectrum sensing influence patterns. In this way, it is possible to increase the number of terminals that may perform spectrum sensing while some other terminals allocated time resources are transmitting data. For example, in step 940, the base station may allocate time resources to each terminal group whose index of differences in spectrum sensing influence patterns has a specific value or less. When time resources are allocated to each terminal group whose index of differences in spectrum sensing influence patterns is 0 in the example of FIG. 12, time period 1 is allocated to terminal A and terminal F, and time period 2 is allocated to terminal B and terminal D. FIG. 13 shows a form in which radio resources are allocated to terminals A, B, C, and D accordingly. In addition, referring to FIG. 13, different frequency resources are allocated to terminal A and terminal F, and different frequency resources are allocated to terminal B and terminal D. In this case, during time period 1, terminal A and terminal F may transmit data, and at the same time, terminal B, terminal D, and terminal F may perform spectrum sensing (see FIG. 10). Also, during time period 2, terminal B and terminal D may transmit data, and at the same time, terminal A, terminal C, and terminal E may perform spectrum sensing (see FIG. 10).

According to the above-described exemplary embodiments of the present invention, by minimizing a quiet period for spectrum sensing, it is possible to increase efficiency in the use of spectrum resources by secondary users.

The above-described exemplary embodiments of the present invention can be written as computer programs and implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, or DVDs), and so on.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of scheduling spectrum sensing in a cognitive radio communication system, the scheduling being performed by a terminal, the method comprising:
classifying terminals in a cell into terminals affecting spectrum sensing and terminals not affecting spectrum sensing; and
performing spectrum sensing when it is determined that uplink signals of other terminals do not affect spectrum sensing based on results of the classification.

2. The method of claim 1, wherein the classifying of the terminals includes classifying the terminals based on uplink radio resource information transmitted from a base station.

3. The method of claim 1, wherein the classifying of the terminals includes classifying the terminals according to amounts of interference respectively caused by the uplink signals of the terminals.

4. The method of claim 1, wherein the classifying of the terminals includes classifying the terminals according to whether or not an amount of interference caused by an uplink signal of each terminal exceeds a predetermined threshold value.

5. The method of claim 1, wherein the performing of the spectrum sensing includes:
determining whether terminals classified as the terminals affecting spectrum sensing are transmitting uplink signals; and
performing the spectrum sensing when it is determined that the terminals are not transmitting uplink signals.

6. The method of claim 5, wherein the performing of the spectrum sensing includes performing no spectrum sensing when it is determined that the terminals are transmitting uplink signals.

7. The method of claim 1, wherein the performing of the spectrum sensing includes performing the spectrum sensing while terminals classified as the terminals not affecting spectrum sensing are transmitting uplink signals.

8. A method of allocating uplink radio resources in a cognitive radio communication system, the allocating being performed by a base station, the method comprising:
deriving influence relationships between data transmission and spectrum sensing of terminals in a cell; and
allocating uplink radio resources to the terminals based on the derived influence relationships.

9. The method of claim 8, wherein the deriving of the influence relationships includes deriving the influence relationships using spectrum sensing influence information collected from the terminals in the cell.

10. The method of claim 8, wherein the influence relationships include spectrum sensing influence patterns indicating whether or not data transmission of each terminal in the cell affects spectrum sensing of other terminals.

11. The method of claim 10, wherein the allocating of the uplink radio resources includes allocating same time resources to terminals having a relatively small difference in spectrum sensing influence patterns.

12. The method of claim 10, wherein the allocating of the uplink radio resources includes:
calculating indices of differences in spectrum sensing influence patterns between the terminals;
grouping the terminals according to the indices of the differences in the spectrum sensing influence patterns; and
allocating the uplink radio resources to the terminals based on results of the grouping.
